(19) United States
(12) Patent Application Publication
(10) Pub. No.: US 2022/0172740 A1
(43) Pub. Date: Jun. 2, 2022

(54) SELF VOICE REHABILITATION AND LEARNING SYSTEM AND METHOD

(71) Applicant: Alexis Pracar, Piedmont, CA (US)

(72) Inventor: Alexis Pracar, Piedmont, CA (US)

(21) Appl. No.: 17/107,834

(22) Filed: Nov. 30, 2020

(51) Int. Cl. G10L 25/75; G10L 21/003

(52) U.S. Cl. CPC G10L 25/75; G10L 21/003

(57) ABSTRACT

Various embodiments of the present invention describe systems and techniques for producing sounds similar to a user's internal perception of the user's voice. In various embodiments, systems and methods may be disclosed. The systems and methods may be configured to receive first sound data associated with a user, determine a transformation based on the first sound data, create a novel utterance based on the first sound data and the transformation, where the novel utterance approximates an internal perception of the user's self-produced speech, and cause a speaker to output the novel utterance.

### TECHNICAL FIELD

The present disclosure relates to systems and techniques for outputting and utilizing an internal perception of a user's voice.

### DESCRIPTION OF RELATED ART

What a person hears in a recording of their own voice sounds markedly different from what that person hears when speaking in real-time. Such difference is primarily due to the contribution of bone-conducted sound to the perception of self-produced speech. Other factors, such as the make-up of an individual's vascular system, may also contribute. Each individual has a unique ratio of bone-conducted signal to air-conducted signal and, thus, the difference between the external perception and internal perception of each individual is different. When listening to a recording, a person only hears the speech as it sounds via air conduction, without the bone conduction through the head and neck. However, when perceiving of their self-produced speech, a person hears a sound that is influenced by both the bone conduction and the air conduction, which is different from what the person would sound in a recording.

### SUMMARY

Various embodiments of the present invention describe systems and techniques for producing sounds similar to a user's internal perception of the user's voice. In a certain embodiment, a system may be disclosed. The system may include a sensor configured to receive a sound uttered by a user, a speaker configured to output a sound, and a processor communicatively coupled to the sensor. The processor may be configured to cause the system to perform operations that include receiving first sound data associated with a user, determining a transformation based on the first sound data, creating a novel utterance based on the first sound data and the transformation, where the novel utterance approximates an internal perception of the user's self-produced speech, and causing the speaker to output the novel utterance.

In another embodiment, a method may be disclosed. The method may include receiving first sound data associated with a user, determining a transformation based on the first sound data, creating a novel utterance based on the first sound data and the transformation, where the novel utterance approximates an internal perception of the user's self-produced speech, and causing a speaker to output the novel utterance.

### BRIEF DESCRIPTION OF THE DRAWINGS

The disclosure may best be understood by reference to the following description taken in conjunction with the accompanying drawings, which illustrate particular embodiments of the present invention.

FIG. 1 illustrates one example of a system configured to provide an internal perception of a user's speech.

FIG. 2 illustrates another example of a system configured to provide an internal perception of a user's speech.

FIG. 3 illustrates an example of outputting a novel utterance associated with an internal perception of a user's speech.

FIG. 4 illustrates an example of near real time outputting of a novel utterance associated with an internal perception of a user's speech.

FIG. 5 illustrates an example of outputting a novel utterance associated with an internal perception of a user's speech based on user feature dimensions.

FIG. 6 illustrates an example configuration of a neural network.

### DETAILED DESCRIPTION

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

In the following description, numerous specific details are set forth in order to provide a thorough understanding of the present invention. Particular example embodiments of the present invention may be implemented without some or all of these specific details. In other instances, well known process operations have not been described in detail in order not to unnecessarily obscure the present invention.

In various embodiments, systems and techniques for creating novel utterances that approximate an internal perception of a user's speech is described herein. As described herein, “internal perception” refers to how a user hears self-produced speech. Internal perception is based on, at least, a combination of bone-conducted sound to air-conducted sound. As each individual experiences a unique ratio of bone-conducted sound to air-conducted sound, the internal perception of each individual differs. The difference in such ratios among different individuals is due to, for example, the differences in physical structure between different individuals.

By contrast, “external perception” refers to how a user's speech sounds to others (e.g., someone proximate to the user hearing what the user is saying). External perception may be, for example, how a user sounds in a recording of the user. A user's internal perception of their speech is generally different from the external perception. As such, when a user, for example, hears a recording of their voice, it can often be an alien experience.

A person perceives their voice through auditory and motor feedback. A person modulates their voice and speech production through a combination of motor and auditory feedback. For example, if a person is able to hear their own voice, the person can activate the motor pathways that would be necessary to produce future sounds and adjustments necessary to obtain other sounds. In general, a person requires feedback from their own actions in order to determine the necessary adjustments. Thus, for example, a person must believe that they are producing a sound and hear the sound through their internal perception to provide the necessary adjustments (e.g., to produce the sound that they wish to produce).

There is evidence that mirror therapy helps in treating phantom-limb pain. Mirror therapy includes the placing of a mirror next to a moving present limb. The brain processes the flipped image as the presence of the absent or dysfunctional limb. The physical therapist can then treat the present limb, causing the brain to fire as if the absent limb were present and to rehabilitate the absent limb.

A person uses visual feedback to modulate their movements. For example, a person may see and direct movement of their limbs throughout their lives through using visual and motor feedback. The link between the motor system and the visual system is so powerful that the visual feedback alone (e.g., seeing the mirror image of the right arm) will activate the motor system of a person. Thus, a person's brain can be duped into thinking it is actually moving a missing limb, even if the limb is missing.

Systems and techniques described herein include a sensor configured to receive a sound uttered by a user, a speaker configured to output a sound, a non-transitory memory, and a processor communicatively coupled to the sensor and the memory. The processor is configured to cause the system to perform operations including receiving first sound data associated with a user, determining a transformation based on the first sound data, creating a novel utterance based on the first sound data and the transformation, wherein the novel utterance approximates an internal perception of the user's self-produced speech, and causing the speaker to output the novel utterance.

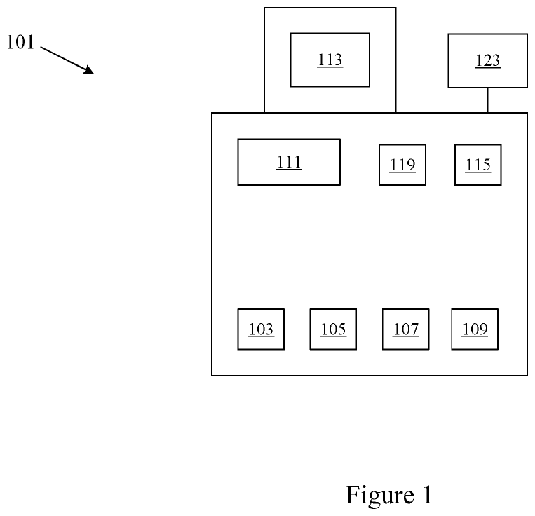

FIG. 1 illustrates one example of a system configured to provide an internal perception of a user's speech. As shown, system 101 includes memory 103, processor 105, sensors 107, network interface 109, output interface 111, speaker 113, notification interface 115, buttons 119, and headphones 123.

In various embodiments, various examples of system 101 configured to perform the techniques described herein may include one or more plug-ins, apps, and/or other programs. Such programs (e.g., plug-ins, apps, and/or other programs) may be implemented on one or more devices, such as electronic devices described herein or on other such devices. Additionally, in various embodiments, such electronic devices may include, for example, devices used for rehab, learning devices, laptops, electronic tablets, smartphones, computers, and/or other such appropriate devices.

Sensors 107 may include one or more devices such as a microphone, another sensor for detecting sound, a light sensor, and/or another sensor configured to detect one or more sounds or aspects of an environment around system 101. Sensors 107 may be configured to, for example, detect any sounds within an environment around system 101. In certain embodiments, sensors 107 may be configured to detect, for example, sound uttered by a user. Sensors 107 may receive such sound uttered by the user and create sound data associated with the sound. The sound data may then be provided to processor 105 for performing the techniques described herein. In various other embodiments, sensors 107 may, additionally or alternatively, include one or more visual or imaging sensors configured to image the user or an environment.

Processor 105 may be configured to provide instructions for performing one or more operations, as described herein. Thus, for example, processor 105 may be configured to receive sound data from sensors 107 and/or network interface 109. Processor 105 may also determine transformations for creating novel utterances as well as provide other instructions, as described herein. Memory 103 may be configured to store one or more instructions (e.g., the instructions provided by processor 105). Thus, memory 103 may store one or more transformations (e.g., transformations associated with a user) and/or sound data such as speech samples. In certain embodiments, memory 103 may also include, for example, data directed to pronunciation, such as pronunciation of sounds, symbols, words, phrases, terms, and other such aspects of languages. In various embodiments, the pronunciations may be for a plurality of different languages and/or dialects. As such, an internal perception of a user may be applied to proper pronunciation using, for example, data of the internal perception of the user's voice (e.g., characteristics of the internal perception of the user's voice) combined with the data directed to pronunciation, to create novel utterances of the user's internal perception correctly saying or pronouncing the of sounds, symbols, words, phrases, terms, and other such aspects of languages.

System 101 may also include network interface 109, which may include a wired and/or wireless data connection such as a plug, USB connection, Bluetooth interface, NFC interface, WiFi connection, and/or other such data connection. Network interface 109 allows for system 101 to communicate and/or exchange data with other devices such as a smart phone, computer, server, and other such devices. As such, network interface 109 allows for system 101 to receive data from such devices. Thus, for example, network interface 109 may receive speech samples or data directed to creating a speech sample from the external device. Such samples may be, for example, sex-matched, age-matched, and/or matched to features (e.g., skull features) of the user to create a speech sample. In certain other embodiments, system 101 may be configured to operate independently without network interface 109, in certain or all instances.

In certain embodiments, system 101 may include output interface 111. Output interface 111 may be, for example, a touch screen or display. Some examples of such interfaces include a liquid crystal display (LCD), a flexible organic light emitting diode (OLED) display, a magnetic display, and a microelectromechanical systems (MEMS) display. Output interface 111 may be configured to communicate information to a user. Thus, for example, output interface may display words, phrases, or sentences for a user to say or that system 101 is outputting at the moment. In certain embodiments, output interface 111 may also receive input, such as when a touch screen is used.

Notification light 115 may turn on, flash and/or blink to communicate information to a user. Thus, for example, notification light 115 may turn on to indicate that system 101 is operating. In certain embodiments, notification light 115 may be used to display system conditions such as battery life, etc. This notification light may be a single color or multiple colors. In particular, the light may display a different color for different types of notifications, such as battery status, sleep mode, awake mode, etc. In other embodiments, notification light 115 may include lights of different shapes displayed for different types of notifications. For instance, awake mode could display a light in the shape of an open eye, sleep mode could display a light in the shape of a closed eye, and battery life can display a light in the shape of a battery, etc. The color of the shaped light might indicate whether the battery is fully charged (e.g. green), partially charged (e.g. yellow), or needs charge (e.g. red).

System 101 may include one or more buttons 119. Button 119 may be used to control the output interface 111, speaker 113, notification light 115, or other parts of the system 101. For instance, it can be used to make a selection presented by the output interface 111, adjust the volume of the speaker 113, and/or activate the notification light 115.

The speaker 113 may be configured to provide sounds for the user. Thus, for example, speaker 113 may provide novel utterances that approximate a user's internal perception of the user's self-produced speech. In various embodiments, system 101 may include, alternatively or additionally, headphones 123. Headphones 123 may also output sounds to the user. Headphones 123 may provide an immersive sound experience to the user, aiding in the generation of internal perception. By approximating the internal perception of a user, more effective therapy (e.g., speech therapy for a user, such as when a user is recovering from a stroke) and/or educational experiences (e.g., learning a foreign language) may be provided to the user. Thus, speaker 113 and/or headphones 123 may aid in directing neural reorganization and rewiring.

After a stroke or traumatic brain injury, a person may suffer from a variety of motor-speech disorders. Such a person may experience problems in the coordination of articulatory movements needed to produce speech as intended. This can manifest in predictable or unpredictable speech errors, depending on the particular location of the stroke or injury. Hearing properly produced words, phrases, and/or sentences consistent with the person's internal perception may allow for quicker and more effective neural reorganization and rewiring, enabling a more effective recovery from the injury. In other examples, acquiring foreign languages, committing study materials to memory, and/or other learning may be improved through the use of sound consistent with that of a user's internal perception.

It should be noted that although the present embodiment shows a certain configuration of the components of system 101, the configuration is illustrative only and does not intend to limit the possible configurations of system 101.

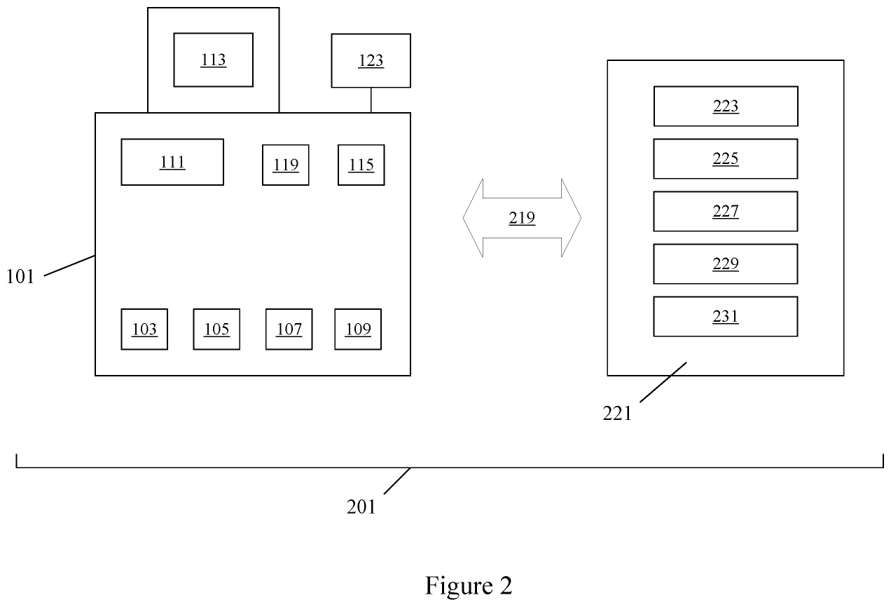

FIG. 2 illustrates another example of a system configured to provide an internal perception of a user's speech. As shown, system 201 of FIG. 2 includes system 101 and remote device 221. System 101 of FIG. 2 is similar to system 101 of FIG. 1 and includes the components of system 101 as described herein. Remote device 221 may be, for example, another electronic device such as a computer, smart phone, tablet, or other device.

System 101 may communicate with remote device 221 via network interface 109. Network interface 109 allows for system 101 to provide data to remote device 221 and/or receive data from remote device 221. In various embodiments, such data may include instructions, sound data, speech samples, and/or other such data. Such communication may occur over data connection 219. Data connection 219 may be a wired, wireless, or other data connection, depending on the chosen communication protocol. Thus, data connection 219 may be a wired network connection, a WiFi connection, a Bluetooth connection, a USB connection, a NFC connection, and/or another type of data connection.

In certain embodiments, remote device 221 includes an output interface 223, processor 225, memory 227, speaker 229, and network interface 231. Remote device 221 may be a smart phone, computer, laptop, tablet, notebook, portable gaming device, and/or other electronic device, as described herein. Remote device 221 may exchange, receive, and/or send communications and/or data with system 101 over data connection 219 using network interface 231.

In certain embodiments, processor 225 may be configured to perform or aid in performing any of the techniques as described herein. For example, system 101 may communicate an age and/or sex of a user. Based on the age and/or sex, processor 225 may provide a matched speech sample. Furthermore, system 101 may communicate measurements and/or approximations of a skull structure of a user. Based on the measurements and/or approximations, speech sample related data may be provided to system 101 from remote device 221. In various embodiments, data may be stored within memory 227. Such data may be, for example, instructions for operation of processor 225.

Remote device 221 may also include speaker 229. The speaker 229 may be configured to provide sounds for the user. Thus, speaker 229 may provide novel utterances that approximate a user's internal perception of the user's self-produced speech. In certain embodiments, remote device 221 may provide such sound to the user, or to a third party (e.g., a physician or other party).

In certain embodiments, remote device 221 may additionally include sensors and other components, as described herein. Such sensors may detect sound, movement, and/or other aspects of the environment proximate to remote device 221. In certain embodiments, the sensors may detect speech from a user and compare such speech to other speech samples of the users. Thus, remote device 221 may then determine any needed adjustments for the novel utterances outputted. Remote device 221 may also include an output interface, such as a touch screen or display. The output interface may also provide information as described herein.

It should be noted that although the present embodiment shows a certain configuration of the components in system 201, the configuration is illustrative only and does not intend to limit the configuration of components.

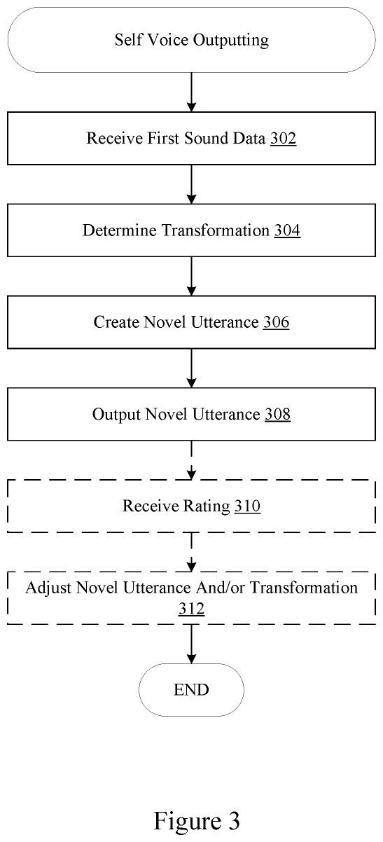

FIG. 3 illustrates an example of outputting a novel utterance associated with an internal perception of a user's speech. FIG. 3 illustrates a technique for creating a novel utterance that matches or substantially matches an internal perception of a user. The techniques for FIGS. 3-5 may be for creating a novel utterance (e.g., a word, phrase, sentence, and/or speech segment) matching or substantially matching (e.g., approximating) what would be internally perceived by a user. Thus, the techniques described herein allows for a user to hear words, phrases, sentences, and/or speech segments from an external source such as a speaker that approximate their internal perception.

In 302, first sound data is received. The first sound data may be associated with a user. The first sound data may be, for example, a user speech sample received from a sensor, data of the user (e.g., sex, age, facial structure), and/or other such data that allows for a transformation to be determined to approximate the internal perception of the user. Thus, first sound data may be sound data received from a speaker, measured by one or more sources (e.g., measured by sensors that may, for example, digitally measure and/or analyze a user's face), entered by a user (e.g., factors or measurements entered into an interface), and/or may be sound data from another source.

In another embodiment, the first sound data may include characteristics of the user such as sex, age, height, weight, and/or other features to create synthesized data. Based on such first sound data, synthesized data may be provided for the user that may include, for example, data that is a sex-matched and/or age-matched for the user. Such a technique may be used if, for example, the user is unable to produce enough sound for a speech sample. In certain embodiments, the user may nonetheless be able to produce vowel sounds or other sounds (e.g., sounds of letters). Such sounds may additionally be included with the first sound data along with the characteristics. Using such sounds may allow the creation of a transformation that includes the natural prosody of the user.

In 304, a transformation is determined based on the first sound data. The transformation may, for example, be used to create a novel utterance that approximates an internal perception of a user's speech. The novel utterance may be, for example, one or more words, phrases, sentences, and/or speech segments. The transformation may be a technique for creating a synthetic voice consistent with the internal perception of the user.

The transformation may be based on the speech data received in 302. Thus, for example, in certain embodiments, the speech data received in 302 may be a speech sample of the user (e.g., obtained by the one or more sensors). Thus, for example, the sensor may receive speech or sounds produced by the user. In certain embodiments, the user may say one or more words to the sensor (e.g., in situations where the user is able to say words), but in other embodiments, the user may produce one or more sounds. The speech data may be associated with an external perception of a user's speech. Based on the speech data received, the transformation may be determined for an internal perception of a user's speech.

In various embodiments, the transformation may be associated with a sound, word, phrase, and/or sentence. In such embodiments, the transformation may be associated with, for example, a set (e.g., predetermined) sound, word, phrase, and/or sentence. In other embodiments, the transformation may be, for example, associated with the general internal perception of the user. Thus, the transformation may be data directed to the general tone, intensity, and/or other aspects of the user's internal perception and may be used to construct one or more sounds, words, phrases, and/or sentences as required.

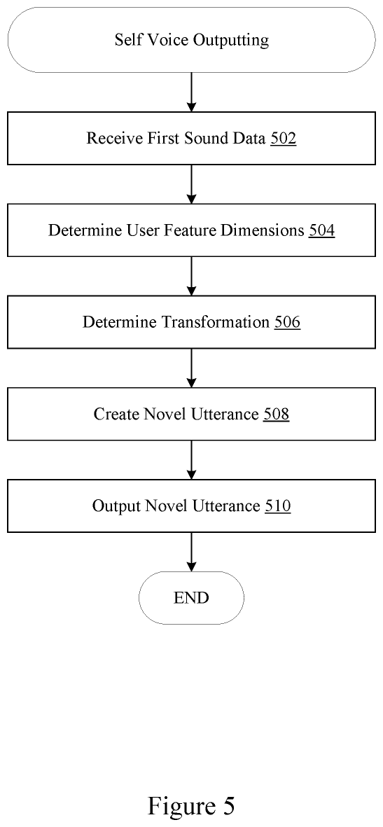

In certain embodiments, the first sound data may additionally include data directed to measurements and/or the geometry of the user's face. Such a technique is additionally described in FIG. 5.

In various embodiments, the transformation may be based on the vocal features of the internal perception. Thus, for example, the transformation may match or approximate how a user speaks vowels, consonants, and other pronunciations of words. The transformation may also change the tone, pitch, and other characteristics of the pronunciations to match the internal perception of the user.

In certain additional embodiments, the transformation may be adjusted. Thus, for example, a transformation may be provided or previewed by the user or another party (e.g., through a speaker or headphones). The transformation may then be rated based on accuracy (e.g., based on how close the user rates the novel utterance to the internal perception of the user's speech). Based on the rating, the transformation may be adjusted. In certain embodiments, feedback may be provided as to how to adjust the transformation (e.g., certain tones may be identified for change). Based on the feedback, the transformation may be adjusted to better conform to the user's internal perception.

In certain embodiments, where a third party not the user is previewing or adjusting the internal perception, the internal perception may then be transformed to an external perception. Such an external perception, which is based on the internal perception, may be determined from features of the user and/or a ratio of the bone-conducted to air-conducted sound, which may be determined as further described in FIG. 5. The third party may adjust the determined external perception until it matches that of the external perception of the user and such adjustments to the external perception may be accordingly reflected in the internal perception. Thus, for example, if the tone of the external perception of a user is adjusted to be higher, the associated internal perception may also become higher. However, the change may not be a one-to-one change due to the features of the user. Such a technique may allow for a more accurate approximation of an internal perception in situations where the user is unable to provide feedback, such as when the user is suffering from an injury or malady and requires rehabilitation.

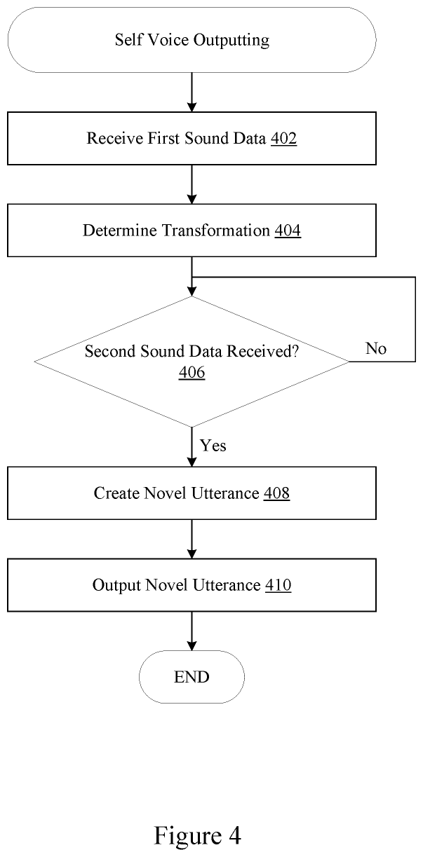

Based on the transformation, a novel utterance may be created in 306. The novel utterance may approximate an internal perception of the user and may be one or more sounds, words, phrases, and/or sentences. In certain embodiments, the transformation may map the sound of the one or more sounds, words, phrases, and/or sentences. In certain embodiments, the user and/or another party may select the novel utterance to be created. Thus, the word, phrase, sentence, and/or sound to be created may be inputted into the device (e.g., through a user interface). In other embodiments, the novel utterance may be detected from the environment. Thus, for example, the speaker may detect what the user is saying and structure the novel utterance based on what is detected. Such an embodiment is further described in FIG. 4.

In various embodiments, the novel utterance may be used for rehabilitation, learning, informational purposes (e.g., for reading of articles and/or documents to the user), and/or other purposes. Thus, for example, novel utterances may be used during rehabilitation (e.g., in speech recovery techniques such as for recovering from strokes) to provide sounds consistent with the internal perception of the user's voice. Such sounds may aid in helping with more rapid recovery by the user. Novel utterances may also be used during learning. For example, if the user is learning a new language, the novel utterance may be that of words or phrases in the new language, pronounced correctly through the internal perception of the user's voice. Additionally, if the user is learning a new subject, the novel utterance may be a summary of a lesson, internally perceived by the user. In certain situations the user may be more likely to retain information that is read as they are internally perceived. As such, for situations such as memorizing facts, the facts may be read to the user as they are internally perceived (to better simulate the user reading the facts themselves) to aid in memorization. Furthermore, additional information, such as e-mails, may also be read to the user as they are internally perceived. Such techniques may be for novelty purposes, or to increase retention and/or understanding of the contents by the user.

The novel utterance may be outputted in 308. Thus, one or more of the speaker, headphones, and other output components described herein may provide the novel utterance. Additional techniques, including any techniques that output sounds to the user, may also be utilized to output the novel utterance.

The novel utterance and/or transformation may be adjusted in 310 and 312, which may be optional portions of the technique of FIG. 3. In 310, ratings may be received as to the accuracy of the novel utterance and/or the transformation. The ratings may be ratings from, for example, the user. Thus, for example, the user may rate the accuracy of the internal perception of the novel utterance and/or offer feedback as to adjustments needed to the internal perception (e.g., changes to the tone, pitch, or other aspects of the internal perception).

Based on the ratings, the novel utterance and/or transformation may be adjusted in 312. Thus, the transformation and/or novel utterance may be adjusted based on the ratings and/or feedback of 310. In certain embodiments, the transformation may be adjusted to more accurately reflect the true internal perception of the user. In various embodiments, the adjustments may be to the system (e.g., algorithm stored in the system) or the ratings and/or feedback may be provided to a machine learning system to refine the machine learning process, as described herein.

In various embodiments, the output may be provided to the user when the user is practicing speech. In certain embodiments, such as the embodiment described in FIG. 4, the novel utterance may be output in real-time and/or near real-time (e.g., within a second of the user uttering a word, phrase, or sentence) to provide a sound similar to what the user would internally perceive the sound if the user had said it. In other embodiments, the output may be provided without any user input such as the user producing the sound. In such embodiments, the sound may be provided to allow for better memorialization and/or speech solely through the repetition of the novel utterance as the user would internally perceive it.

FIG. 4 illustrates an example of near real time outputting of a novel utterance associated with an internal perception of a user's speech. As described herein, “near real time” refers to a period substantially within a time when a sound or phrase is uttered by the user. Thus, for example, “near real time” may refer to a period within one second or less after the user produces a sound. In various embodiments, the techniques described herein may output the novel utterance as quickly as technically possible in response to the user's speech. As such, the techniques allow for the user to hear the novel utterance as if the user were saying it.

402 and 404 of FIG. 4 may be similar to 302 and 304 of FIG. 3. In 406, a determination may be made as to whether second sound data is received. The second sound data may be, for example, one or more sounds, words, phrases, and/or sentences uttered by a user and detected by a sensor of the system. Thus, for example, in speech therapy, the user may utter a sound and the system may correct the sound to be the proper pronunciation, as it would be internally perceived, to aid in the therapy. The user may also say words in a foreign language and, the system may provide the correct pronunciation according to the internal perception of the user.

In other embodiments, one or more sounds, words, phrases, and/or sentences may be inputted into the system for creating the novel utterance. Thus, for example, if the system is directed to aiding the user in learning a new language, words, phrases, and/or sentences that the user is supposed to learn may be input into the system. The system may then output the sound of the words, phrases, and/or sentences as they are properly pronounced according to the internal perception of the user. In systems where the novel utterance is used for learning or informational purposes, the system may read a sound, word, phrase, and/or sentence according to the internal perception of the user. If second sound data related to one or more sounds, words, phrases, and/or sentences are received, the technique may continue to 408. If second sound data is not received, the technique may continue in 406 until second sound data is received.

Based on the second sound data, the novel utterance may be created in 408. The novel utterance, in certain embodiments, may be based on and/or be a reflection of the second sound data. That is, the novel utterance may be the internal perception of the sounds, words, phrases, and/or sentences received as part of the second sound data. In certain embodiments, such as for therapy, the user may be unable to pronounce certain sounds, words, phrases, and/or sentences like the user was previously able to pronounce them. The novel utterance may then be created based on the transformation so that it sounds similar to the internal perception of the user before any injury or illness suffered by the user. In certain embodiments, the speaker and/or headphones may then output the novel utterance in 410, similar to 308 of FIG. 3. The user may then hear the novel utterance (e.g., in near real time in certain instances).

FIG. 5 illustrates an example of outputting a novel utterance associated with an internal perception of a user's speech based on user feature dimensions. 502 of FIG. 5 may be similar to 302 of FIG. 3.

In 504, one or more features of the user may be determined. Such features may be determined by, for example, one or more sensors of the system. Thus, for example, a system may, additionally or alternatively, include a sensor that is a measurement device such as a three-dimensional (3D) scanning device that measures the geometries of a user's face. The 3D scanning device may determine the features and/or dimensions of a user's head and/or neck. In other embodiments, additionally or alternatively, a MRI or other 3D image of the user's face may be provided as part of 504.

From such data the ratio of bone-conducted sound to air-conducted sound of a user, as well as other features such as the features of the vascular system, may be estimated. For example, certain features may be correlated to certain ratios and/or tone changes in internal perceptions (e.g., features, such as bone features, around the jaw and ear may be correlated with specific pitch or tone differences between external and internal perceptions). The 3D scanning, MRI, and/or other 3D images may be measured and/or analyzed. Based on the analysis, a ratio of bone-conducted sound to air-conducted sound, features of the user's head, features of the user's vascular system, and/or other factors of the user may be determined. For example, the dimensions of the internal air pathways of the user versus the bone volume of the user may be used to determine the ratio.

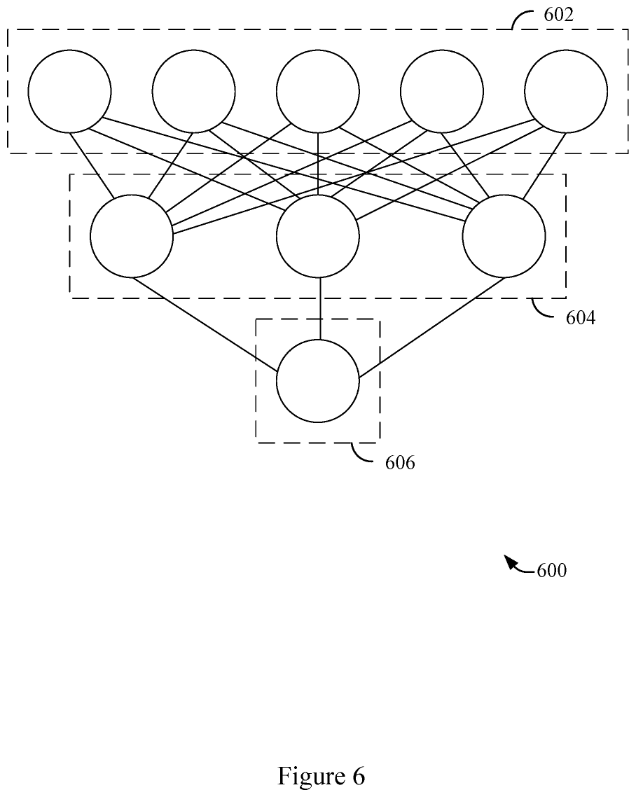

In various embodiments, an algorithm may be determined (e.g., through machine learning techniques such as that described in FIG. 6) that may, for example, allow for a correlation between features and dimensions of a user's head and the internal perception of the user's voice (e.g., the changes between the external perception and the internal perception). In certain embodiments, a user may rate and/or adjust the created internal perception based on its accuracy. The ratings from the user may further refine the created internal perception, allowing for improved accuracy.

Based on such ratio, the transformation may then be determined for the user, in 506. 506, 508, and 510 of FIG. 5 may be similar to 304, 306, and 308 of FIG. 3. Accordingly, a novel utterance may be output that may match or substantially match the internal perception of the user if the user had spoken it.

FIG. 6 illustrates an example configuration of a neural network. In various embodiments, the neural network may be, for example, a neural networking for machine learning. Such machine learning may allow for, for example, more accurate determination of the changes between an internal perception and an external perception of a user based on factors such as the user's gender, height, weight, age, and body features.

FIG. 6 illustrates a neural network 600 that includes input layer 602, hidden layers 604, and output layer 606. Neural network 600 may be a machine learning network that may be trained to determine the internal perception of a user based on the user's characteristics and/or features. In other embodiments, neural network 600 may be a machine learning network used for generating sounds, words, phrases, sentences, and/or paragraphs as internally perceived, as described herein.

Neural network 600 may be trained with inputs that include previously determined internal perceptions, the features of the user, and/or the accuracy thereof of the internal perceptions (e.g., the rated accuracies of the generated internal perceptions). Input layer 602 may include such inputs. Hidden layers 604 may be one or more intermediate layers where logic is performed to determine the accuracy of the internal perceptions based on the rated performance. Output layer 606 may result from computation performed within hidden layers 604 and may output correlations of user characteristics and/or features to internal perceptions and/or other factors of internal perceptions.

While the invention has been particularly shown and described with reference to specific embodiments thereof, it will be understood by those skilled in the art that changes in the form and details of the disclosed embodiments may be made without departing from the spirit or scope of the invention. It is therefore intended that the invention be interpreted to include all variations and equivalents that fall within the true spirit and scope of the present invention.

What is claimed is:

1. A system comprising:
a sensor configured to receive a sound uttered by a user;
a speaker configured to output a sound; and
a processor communicatively coupled to the sensor, the processor configured to cause the system to perform operations comprising:
receiving first sound data associated with a user;
determining a transformation based on the first sound data;
creating a novel utterance based on the first sound data and the transformation, wherein the novel utterance approximates an internal perception of the user's self-produced speech; and
causing the speaker to output the novel utterance.

2. The system of claim 1, wherein the first sound data comprises a user speech sample received from the sensor.

3. The system of claim 2, wherein the transformation is configured to substantially match the internal perception of the user's speech.

4. The system of claim 1, wherein the first sound data comprises a sex-matched and age-matched speech sample.

5. The system of claim 4, wherein the first sound data further comprises a user vowel sound sample received from the sensor.

6. The system of claim 1, wherein the transformation is based on a ratio of bone-conducted sound to air-conducted sound.

7. The system of claim 6, further comprising:
a scanning device configured to measure a feature of the user, wherein the ratio is determined from the measured features of the user.

8. The system of claim 1, further comprising:
receiving second sound data comprising a word or phrase spoken by the user, wherein the novel utterance is further based on the word or phrase.

9. The system of claim 8, wherein the speaker is a headphone.

10. The system of claim 8, wherein the novel utterance is created substantially simultaneously to receiving the sound second data.

11. A method comprising:
receiving first sound data associated with a user;
determining a transformation based on the first sound data;
creating a novel utterance based on the first sound data and the transformation, wherein the novel utterance approximates an internal perception of the user's self-produced speech; and
causing a speaker to output the novel utterance.

12. The method of claim 11, wherein the first sound data comprises a user speech sample received from a sensor.

13. The method of claim 12, wherein the transformation is configured to substantially match the internal perception of the user's speech.

14. The method of claim 11, wherein the first sound data comprises a sex-matched and age-matched speech sample.

15. The method of claim 14, wherein the first sound data further comprises a user vowel sound sample received from a sensor.

16. The method of claim 11, wherein the transformation is based on a ratio of bone-conducted sound to air-conducted sound.

17. The method of claim 16, wherein the ratio is determined from a feature of the user measured by a scanning device.

18. The method of claim 11, further comprising:
receiving second sound data comprising a word or phrase spoken by the user, wherein the novel utterance is further based on the word or phrase.

19. The method of claim 18, wherein the speaker is a headphone.

20. The method of claim 18, wherein the novel utterance is created substantially simultaneously to receiving the sound second data.
